(19) United States
(12) Patent Application Publication
(10) Pub. No.: US 2007/0076413 A1
(43) Pub. Date: Apr. 5, 2007

(54) Highly integrated power LED lamp

(75) Inventor: Fabrizio Mingozzi, Varzo (IT)

Correspondence Address: MODIANO & ASSOCIATI, Via Meravigli, 16, MILAN, 20123, IT

(73) Assignee: TERZA LUCE S.R.L.

(21) Appl. No.: 11/528,505

(22) Filed: Sep. 28, 2006

(30) Foreign Application Priority Data
Oct. 5, 2005 (IT) MI2005A001874

(51) Int. Cl. F21V 21/00

(52) U.S. Cl. 362/249

(57) ABSTRACT

A power LED lamp, particularly usable in modular luminaires of the enclosure type, comprising a lamp body which is also adapted to act as a heat sink, a plurality of power LEDs adapted to be supported by a supporting element accommodated within the lamp body, a plurality of lenses arranged at each of the LEDs; the lamp further comprises a voltage stabilizing circuit and a current stabilizing circuit which are integrated within the body of the lamp, so that the lamp can be used with traditional power supplies used for halogen lamps.

The present invention relates to a highly integrated power LED lamp. More particularly, the invention relates to a power LED lamp which is particularly adapted as a replacement of a low-voltage halogen lamp, for example AR111, used in modular luminaires of the enclosure type.

### BACKGROUND OF THE INVENTION

As is known, enclosure-type structures, i.e., luminaires inserted in a frame adapted to accommodate a plurality of lamps and arrangeable on a wall or ceiling, are currently commercially widespread.

Such frames normally use low-voltage halogen lamps, for example AR111, which are connected to a common power supply. If one chooses to replace such lamps with LED lamps, for an equal power level, the LED lamps cannot be easily interchangeable with AR111 halogen lamps, since they would require an appropriately provided transformer, which would have to be installed in the enclosures, with evident problems in terms of costs and time expenditure.

Currently, enclosures are provided with AR111 halogen lamps which are not interchangeable with power LED lamps, because currently available LED lamps require preparation of the enclosure with a suitable power supply.

### SUMMARY OF THE INVENTION

The aim of the present invention is to provide a power LED lamp which can be interchanged easily with halogen lamps, for example AR111, normally present in modular luminaires of the enclosure type, without having to modify the power supply provided for the enclosure or the structure of the enclosure proper.

Within this aim, an object of the present invention is to provide a power LED lamp which has no areas in which the voltage is dangerous for contact and no areas where a short-circuit might be dangerous.

Another object of the present invention is to provide a power LED lamp which has no areas on its outer surface which reach high temperatures such as to cause injury or damage.

Another object of the present invention is to provide a LED lamp which is highly reliable, relatively simple to provide and at competitive costs, which lasts much longer than AR111 halogen lamps, and has no heat in the generated light beam, with dimensions equal to those of said AR111 halogen lamps.

This aim and these and other objects, which will become better apparent hereinafter, are achieved by a power LED lamp, particularly usable in modular luminaires of the enclosure type, comprising a lamp body which is also adapted to act as a heat sink, a plurality of power LEDs adapted to be supported by a supporting element accommodated within said lamp body, a plurality of lenses arranged at each of said LEDs, characterized in that it comprises a voltage stabilizing circuit and a current stabilizing circuit which are integrated within the body of said lamp, so that said lamp can be used with traditional power supplies used for halogen lamps.

### BRIEF DESCRIPTION OF THE DRAWINGS

Further characteristics and advantages of the invention will become better apparent from the description of a preferred but not exclusive embodiment of the lamp according to the invention, illustrated by way of non-limiting example in the accompanying drawings, wherein:

FIG. 1 is an exploded perspective view of the LED lamp according to the present invention;

FIG. 2 is a rear perspective view of the LED lamp according to the present invention;

FIG. 3 is a front perspective view of the LED lamp according to the present invention;

FIG. 4 is a view of an enclosure adapted to accommodate one or more lamps according to the invention.

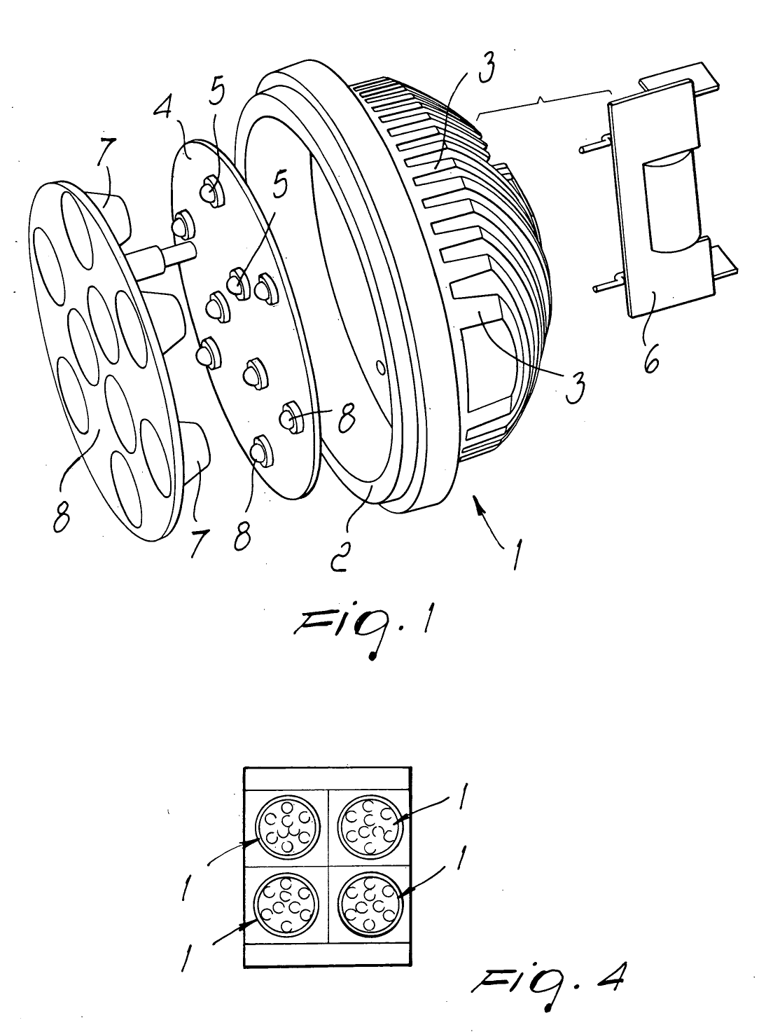

### DESCRIPTION OF THE PREFERRED EMBODIMENTS

With reference to the figures, the power LED lamp according to the present invention, generally designated by the reference numeral 1, comprises a lamp body 2, which acts as a heat sink by being provided with a plurality of fins 3 which are indeed adapted to dissipate the heat generated by a plurality of power LEDs, which are accommodated within the lamp body and are arranged on a disk-like element 4. The power LEDs, designated by the reference numeral 5, are thus arranged in a selected position on the disk-like element 4, which is accommodated within the body 2 of the lamp.

The disk-like element 4 further supports one or more current stabilizing circuits.

The remaining part of the electronic circuit of the power LED lamp according to the invention is arranged in a voltage stabilizing circuit 6, which is accommodated conveniently in a seat provided between the fins 3 of the body 2 of the lamp which acts as a heat sink.

Substantially, the voltage stabilizing circuit 6, as shown in FIG. 2, is coupled directly to the body of the lamp, thus allowing to use the power LED lamp according to the invention with normal power supplies used in modular luminaires of the enclosure type, thus allowing to replace existing AR111 halogen lamps with power LED lamps without any problem. Moreover, the lamp according to the invention is completed by a plurality of conical lenses 7, which are arranged at each of the LEDs 5 and are provided so as to protrude from a disk-like element 8, which acts as a covering for the body 2 of the lamp, which is dome-shaped.

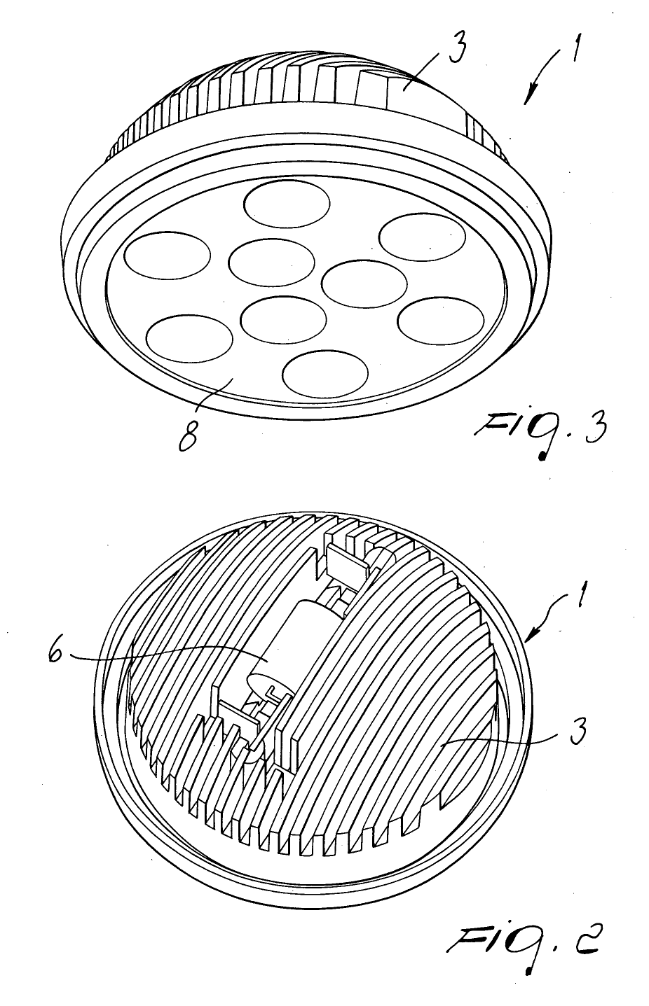

Accordingly, the lamp in the assembled condition has the appearance shown in FIG. 3.

No external area of the lamp is at such a high temperature as to cause injury or damage and there is no area where the voltage might be dangerous for contact if a low-voltage safety power supply is used.

Optionally, it is possible to provide an element for covering the voltage stabilizing circuit 6, so as to protect it further, although, since it is coupled to the lamp body 2, in particular arranged between the fins 3, it already enjoys an inherent protection.

Substantially, therefore, the power LED lamp according to the present invention can replace halogen lamps, for example AR111, accommodated in modular luminaires of the enclosure type, without having to replace the power supply with a power supply suitable for LED lamps, since the power LED lamp itself accommodates and integrates therein both the current stabilizing circuit and the voltage stabilizing circuit, so that it is possible to use the conventional power supply used to supply power to ordinary halogen lamps.

In practice it has been found that the power LED lamp according to the invention fully achieves the intended aim and objects, since it can be used instead of an AR111 halogen lamp by utilizing its power supply portion, thus allowing to obtain lighting with a luminous flux of improved quality.

The variations of the power LED lamp which comprise the integrated or integratable power supply for mains voltages between 230 V and 110 V 50/60 Hz and the version with RGB LEDs (color-changing) with integrated or integratable electronics fall within the scope of the same inventive concept.

The lamp thus conceived is susceptible of numerous modifications and variations, all of which are within the scope of the appended claims; all the details may further be replaced with other technically equivalent elements.

In practice, the materials used, as well as the contingent shapes and dimensions, may be any according to requirements and to the state of the art.

The disclosures in Italian Patent Application No. MI2005A001874 from which this application claims priority are incorporated herein by reference.

What is claimed is:

1. A power LED lamp, particularly usable in modular luminaires of the enclosure type, comprising a lamp body which is also adapted to act as a heat sink, a plurality of power LEDs adapted to be supported by a supporting element accommodated within said lamp body, a plurality of lenses arranged at each of said LEDs, further comprising a voltage stabilizing circuit and a current stabilizing circuit which are integrated within the body of said lamp, so that said lamp can be used with traditional power supplies used for halogen lamps.

2. The lamp according to claim 1, wherein said lamp body is provided with a plurality of heat dissipation fins.

3. The lamp according to claim 1, wherein said current stabilizing circuit is accommodated on said element for supporting said LEDs and said voltage stabilizing circuit is integrated within the body of said lamp.

4. The lamp according to claim 3, wherein said voltage stabilizing circuit is inserted between the fins of the body of the lamp.

5. The lamp according to claim 1, wherein said voltage stabilizing circuit is inserted completely within said lamp body, so as to not protrude from it.

6. The lamp according to claim 1, comprising a covering element which is adapted to support said lenses arranged at said LEDs, in order to close said lamp body.

7. A modular luminaire of the enclosure type, comprising one or more lamps according to claim 1.
